(19) United States
(12) Patent Application Publication
(10) Pub. No.: US 2024/0192016 A1
(43) Pub. Date: Jun. 13, 2024

(54) INFORMATION PROCESSING APPARATUS

(71) Applicant: TOYOTA JIDOSHA KABUSHIKI KAISHA, Toyota-shi Aichi-ken (JP)

(72) Inventor: Tadahiro KASHIWAI, Nagoya-shi Aichi-ken (JP)

(73) Assignee: TOYOTA JIDOSHA KABUSHIKI KAISHA, Toyota-shi Aichi-ken (JP)

(21) Appl. No.: 18/529,215

(22) Filed: Dec. 5, 2023

(30) Foreign Application Priority Data
Dec. 7, 2022 (JP) 2022-195690

(51) Int. Cl. G01C 21/00

(52) U.S. Cl. CPC G01C 21/3811; G01C 21/3837

(57) ABSTRACT

An information processing apparatus acquires first data about an amount of fuel or power consumed when a first vehicle passes through each of a plurality of first road segments. Furthermore, the information processing apparatus generates, based on the first data, first information on the fuel or power consumption amounts of the first vehicle in a section of a predetermined length that includes the first road segment. the information processing apparatus maps the first information on the first road segment on a road map.

### CROSS REFERENCE TO THE RELATED APPLICATION

This application claims the benefit of Japanese Patent Application No. 2022-195690, filed on Dec. 7, 2022, which is hereby incorporated by reference herein in its entirety.

### BACKGROUND

### Technical Field

The present disclosure relates an information processing apparatus.

### Description of the Related Art

Onboard apparatuses capable of outputting fuel efficiency information about vehicles have been widespread. In connection therewith, for example, Patent Literature 1 discloses an onboard apparatus that evaluates and outputs fuel efficiency of the own vehicle taking into account traveling distance, road type, congestion situation, and the like.

### CITATION LIST

### Patent Literature

Patent Literature 1: Japanese Patent Laid-Open No. 11-180185

### SUMMARY

An object of the present disclosure is to evaluate the fuel efficiency of a vehicle.

One aspect of an embodiment of the present disclosure may be an information processing apparatus including a controller, the controller being configured to execute: acquiring first data about an amount of fuel or power consumed when a first vehicle passes through each of a plurality of first road segments; generating, based on the first data, first information on the fuel or power consumption amounts of the first vehicle in a section of a predetermined length that includes the first road segment; and mapping the first information on the first road segment on a road map.

One aspect of an embodiment of the present disclosure may be an information processing apparatus including a controller, the controller being configured to execute: acquiring first data about an amount of fuel or power consumed when a first vehicle passes through a first road segment; acquiring second data about amounts of fuel or power consumed when a plurality of second vehicles pass through the first road segment; generating, based on the first and second data, first information that is a result of comparing the fuel or power consumption amounts in a section of a predetermined length that includes the first road segment, between the first vehicle and the plurality of second vehicles; and mapping the first information on the first road segment on a road map.

As another aspect, a program for causing a computer to execute the above method or a computer-readable storage medium that non-transitorily stores the program is given.

According to the present disclosure, it is possible to evaluate the fuel efficiency of a vehicle.

### BRIEF DESCRIPTION OF THE DRAWINGS

FIG. 1 is a schematic diagram of a vehicle system according to a first embodiment;

FIG. 2 is a diagram illustrating components of a vehicle according to the first embodiment;

FIG. 3 illustrates an example of fuel efficiency information generated by an onboard apparatus;

FIG. 4 is a diagram illustrating a flow of data in the onboard apparatus according to the first embodiment;

FIG. 5A is a diagram illustrating a method for evaluating fuel efficiency;

FIG. 5B is a diagram illustrating the method for evaluating fuel efficiency;

FIG. 6 is an example of data for defining an evaluation value;

FIG. 7 is a diagram illustrating the evaluation value calculated for each road segment;

FIG. 8 illustrates an example of a fuel efficiency map generated by the onboard apparatus;

FIG. 9 is a flowchart of a process executed by the onboard apparatus in the first embodiment.

FIG. 10 is a schematic diagram of a vehicle system according to a second embodiment;

FIG. 11 is a diagram illustrating components of a server apparatus according to the second embodiment;

FIG. 12 is a diagram illustrating a flow of data in the onboard apparatus according to the second embodiment;

FIG. 13 is a diagram illustrating a method for comparing fuel efficiencies;

FIG. 14 is a sequence diagram illustrating a flow of data between the onboard apparatus and the server apparatus;

FIG. 15 illustrates an example of information provided at the same time with the fuel efficiency map; and

FIG. 16 illustrates an example of information provided at the same time with the fuel efficiency map.

### DESCRIPTION OF THE EMBODIMENTS

Recently, an onboard apparatus capable of outputting fuel efficiency information about the own vehicle has been widespread. The fuel efficiency information is calculated, for example, as an average value of fuel consumption amounts per distance. The average value of fuel consumption amounts can be reset at a predetermined timing. Thereby, a fuel efficiency for any section can be measured.

Furthermore, an onboard apparatus capable of mapping fuel efficiency information about the own vehicle on a map is known. For example, an evaluation result is generated for each predetermined road section (referred to as a road segment) based on fuel consumption information, and a graphic representing the evaluation result is superimposed on a map. Thereby, it is possible to visualize in which section what level of a fuel efficiency is obtained.

However, if the distance of the road segment is short (for example, 100 m), the evaluation result may fluctuate for each short section, making it difficult to see the result.

The information processing apparatus according to the first aspect of the present disclosure solves this problem.

An information processing apparatus according to the first aspect of the present disclosure may comprise a controller being configured to execute: acquiring first data about an amount of fuel or power consumed when a first vehicle passes through each of a plurality of first road segments; generating, based on the first data, first information on the fuel or power consumption amounts of the first vehicle in a section of a predetermined length that includes the first road segment; and mapping the first information on the first road segment on a road map.

The road segment is such that is obtained by dividing a road that the first vehicle can travel into a plurality of sections. The road segment may be a road link that couples road nodes (branch points) or may be such that is obtained by subdividing a road link.

The first data may be data indicating the amount of fuel or power consumed when the first vehicle passes through each of a plurality of first road segments. When the information processing apparatus is mounted on the first vehicle, the first data can be acquired from an electronic control unit of the own vehicle. Alternatively, when the information processing apparatus is a sever apparatus, the first data may be received from the first vehicle by wireless communication.

Based on the first data, the controller generates information on fuel or power consumption amount in a section of a predetermined length that includes the first road segment (first information. Hereinafter, it is also referred to as fuel efficiency information). Further, the controller maps the first information to the first road segment on the road map. The first information may be information that evaluates the fuel efficiency and power consumption of the first vehicle (for example, the first information may be information in which the average value of fuel consumption and power consumption is classified into classes).

For example, the controller may generate graphics corresponding to the obtained fuel consumption and power consumption for a certain road segment and overlay it on the target road segment.

The graphic may be, for example, a color showing the goodness of fuel efficiency or power consumption. As a result, it is possible to easily grasp the sections where fuel efficiency and power consumption are good and the sections where they are not.

At this time, the controller takes a longer section for actually acquiring the first information than the road segment for displaying the first information.

For example, when the road segments are arranged in the order of A, B, and C, the first information is acquired based on the amount of fuel consumed in the three sections A to C, and this is mapped to the road segment B.

In this way, by taking a longer section for actually acquiring the first information than the road segment for which the first information is displayed, the value is equalized compared to the case where the road segment alone is processed, and the road map after mapping is easier to see.

The information processing apparatus according to the second aspect of the present disclosure is an information processing apparatus that evaluates the fuel consumption (power consumption) of a first vehicle based on the fuel consumption (power consumption) information of the first vehicle and the fuel consumption (power consumption) information of a plurality of second vehicles traveling in the same section.

An information processing apparatus according to the second aspect of the present disclosure may comprise a controller being configured to execute: acquiring first data about an amount of fuel or power consumed when a first vehicle passes through a first road segment; acquiring second data about amounts of fuel or power consumed when a plurality of second vehicles pass through the first road segment; generating, based on the first and second data, first information that is a result of comparing the fuel or power consumption amounts in a section of a predetermined length that includes the first road segment, between the first vehicle and the plurality of second vehicles; and mapping the first information on the first road segment on a road map.

The second data may be data about the fuel or power consumption amounts of the plurality of vehicles (the second vehicles) in the same road segment on which the first vehicle traveled. The plurality of second vehicles may be a plurality of vehicles different from the first vehicle or may be a plurality of vehicles including the first vehicle.

For example, the second data can be a set of fuel or power consumption amounts of the plurality of second vehicles in the first road segment.

The controller may compare the fuel or power consumption amounts (hereinafter, referred to simply as “consumption amounts”) in the first road segment, between the first vehicle and the second vehicles, based on the first and second data. The comparison can be made, for example, based on “how many cc of fuel each of the first vehicle and the second vehicles consumed in the first road segment”.

Since the plurality of second vehicles are targeted, an average value or a deviation value may be used for the comparison. For example, after determining an average value of consumption amounts of the plurality of second vehicles, a ratio between the average value and the consumption amount of the first vehicle may be determined. Alternatively, after determining a variance of the consumption amounts of the plurality of second vehicles, a deviation of the consumption amount of the first vehicle may be determined. Alternatively, a percentile of the consumption amount of the first vehicle relative to the consumption amounts of the plurality of second vehicles may be determined.

The fuel or power efficiency of the first vehicle can be relatively evaluated by the above methods.

In the second aspect, the control unit takes a longer section that actually acquires the first information than the road segment that displays the first information. In the case of the above example, based on the amount of fuel consumed in the road segment A to C, a comparison of fuel consumption amount is performed between the first vehicle and a plurality of second vehicles, and the result is mapped to the road segment B.

Thereby, as in the first aspect, it becomes possible to equalize the fluctuation of the value.

Furthermore, the controller may select the second data to be used for the comparison.

In the case of comparing fuel or power consumption amounts, it is desirable that conditions among vehicles, for example, vehicle models, vehicle sizes, drive systems, and the like are the same. Therefore, vehicles having the same attribute as the first vehicle may be selected as the second vehicles to acquire second data corresponding to the vehicles.

Alternatively, vehicles that traveled the first road segment under the same situation as the first vehicle may be selected as the second vehicles. Matching of conditions, such as day of the week, time zone, and date, can improve the accuracy of the comparison.

The controller may provide the road map on which the comparison result is mapped, to an occupant of the first vehicle. The road map may be outputted via a display device or may be transmitted to an external apparatus (for example, a computer carried by the occupant).

Specific embodiments of the present disclosure will be described below based on drawings. A hardware configuration, a module configuration, a function configuration, and the like described in each embodiment are not intended to limit the technical scope of the disclosure only thereto unless otherwise stated.

### First Embodiment

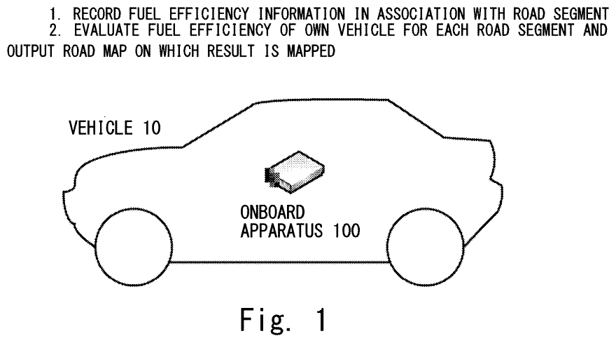

An outline of a vehicle system according to a first embodiment will be described with reference to FIG. 1. The vehicle system according to the present embodiment is configured including a vehicle 10 mounted with an onboard apparatus 100. The vehicle system may include a plurality of vehicles 10 (and onboard apparatuses 100).

The vehicle 10 is a vehicle that is mounted with the onboard apparatus 100 and is capable of providing information about fuel efficiency of an own vehicle) for an occupant. In the description below, information in which any road segment and an amount of fuel consumed in the road segment are associated will be referred to as “fuel efficiency information”.

The onboard apparatus 100 stores the amount of fuel consumed during driving as fuel efficiency information in association with the road segment traveled. When the vehicle 10 finishes running, the onboard apparatus 100 acquires the stored fuel efficiency information. This fuel efficiency information includes fuel efficiency information for the own vehicle on one or more road segments traveled by the vehicle 10. The onboard apparatus 100 evaluates the fuel efficiency information of the own vehicle based on the stored fuel efficiency information of the own vehicle, and maps the result on a road map for each road segment.

Thereby, the driver of the vehicle 10 can recognize how fuel efficient the driver is driving.

Components constituting the system will be described.

The vehicle 10 is configured including the onboard apparatus 100 and an electronic control unit (also referred to as an ECU).

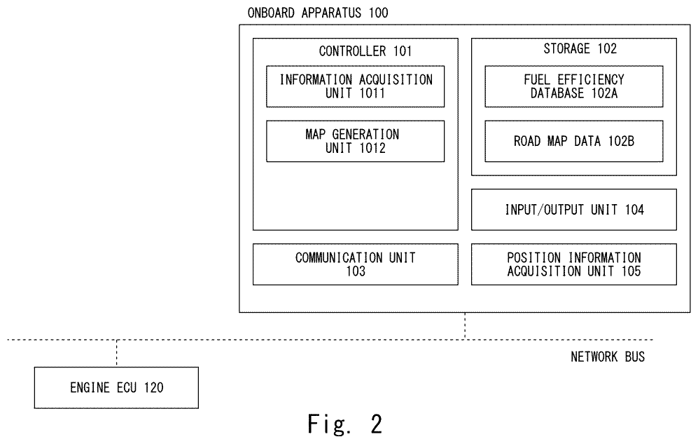

FIG. 2 is a diagram illustrating components of the vehicle 10 according to the present embodiment. The vehicle 10 according to the present embodiment is configured including the onboard apparatus 100 and an engine ECU 120.

Though a single ECU is exemplified in the present example, the vehicle 10 may include a plurality of ECUs responsible for different vehicle components. As the plurality of ECUs, for example, a body ECU, a hybrid ECU, and a power train ECU can be exemplified. The ECUs may be divided according to functions. For example, the ECUs may be divided into an ECU that executes a security function, an ECU that executes an automatic parking function, an ECU that executes a remote control function, and the like.

First, the engine ECU 120 will be described.

The engine ECU 120 is an electronic control unit that controls drive-system components of the vehicle 10. The engine ECU 120 has a function of periodically communicating with the drive-system components via an onboard network.

The engine ECU 120 can be configured as a computer that includes processors such as a CPU and a GPU, main memories such as a RAM and a ROM, and auxiliary storage devices such as an EPROM, a disk drive, and a removable medium.

The engine ECU 120 is configured to be capable of communicating with a fuel injection device of the vehicle 10 to acquire a fuel consumption amount. The engine ECU 120 can acquire, for example, a liquid volume (cc) of fuel consumed per unit time.

The vehicle 10 may include a plurality of ECUs. The plurality of ECUs may be ECUs that control components of different systems, for example, a body system, an electric system, and a power train system, respectively.

Next, the onboard apparatus 100 will be described.

The onboard apparatus 100 is an apparatus that provides information for the occupant of the vehicle (for example, a car navigation apparatus). The onboard apparatus 100 is also referred to as a car navigation apparatus, an infotainment apparatus, or a head unit. It is possible to provide navigation or entertainment for the occupant of the vehicle by the onboard apparatus 100.

The onboard apparatus 100 may have a function of performing wireless communication with an external network. The onboard apparatus 100 may have a function of downloading traffic information, road map data, music, video and the like by communication with the external network of the vehicle 10. The onboard apparatus 100 may be an apparatus capable of cooperating with a smartphone or the like.

The onboard apparatus 100 can be configured as a computer that includes processors such as a CPU and a GPU, main memories such as a RAM and a ROM, and auxiliary storage devices such as an EPROM, a hard disk drive, and a removable medium. In the auxiliary device, an operating system (OS), various kinds of programs, various kinds of tables, and the like are stored, and functions meeting predetermined purposes as described later can be realized by executing the programs stored in the auxiliary device. A part or all of the functions, however, may be realized by a hardware circuit like an ASIC and an FPGA.

The onboard apparatus 100 is configured including a controller 101, a storage 102, a communication unit 103, an input/output unit 104, and a position information acquisition unit 105.

The controller 101 is an operation unit that realizes various kinds of functions of the onboard apparatus 100 by executing a predetermined program. The controller 101 may be realized, for example, by a CPU.

The controller 101 is configured including two function modules of an information acquisition unit 1011 and a map generation unit 1012. Each function module may be realized by executing a stored program by the CPU.

The information acquisition unit 1011 periodically acquires data indicating a fuel consumption amount per unit time from the engine ECU 120. Furthermore, the information acquisition unit 1011 acquires information about a road segment that the vehicle 10 is traveling from the position information acquisition unit 105 to be described later, and then generates fuel efficiency information by associating the road segment with the fuel consumption amount.

The fuel efficiency information may be generated, for example, each time the vehicle 10 enters a new road segment.

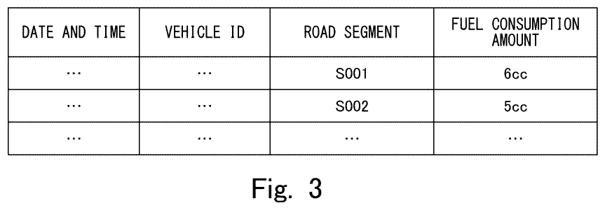

FIG. 3 illustrates an example of the fuel efficiency information generated by the information acquisition unit 1011. As illustrated, the fuel efficiency information is configured including fields of date and time, vehicle ID, vehicle attribute, road segment, and fuel consumption amount.

In the date and time field, information about a date and time when the information is generated is stored. In the road segment field, an identifier of a road segment that the vehicle 10 traveled is stored. In the fuel consumption amount field, a value indicating an amount of fuel consumed in the road segment is stored.

The fuel efficiency information generated by the information acquisition unit 1011 is stored in a fuel efficiency database 102A of the storage 102.

The map generation unit 1012 evaluates the fuel efficiency of the vehicle based on the stored fuel efficiency information, and maps the result to the road map in a road segment unit.

Specifically, the map generation unit 1012 identifies a plurality of road segments included in the route traveled by the own vehicle, and acquires fuel efficiency information corresponding to the specified road segment from the fuel efficiency database 102A.

Then, based on the acquired fuel efficiency information, a value of evaluation is calculated to evaluate the good fuel efficiency of the own vehicle.

The value of evaluation may be, for example, a numerical value representing the fuel efficiency itself (a numerical value representing the amount of fuel consumed per unit distance), or may be a rank classification of fuel efficiency.

The map generation unit 1012 generates a graphic corresponding to the calculated evaluation value, and outputs the graphic by superimposing the graphic on the corresponding road segment on a road map. It is desirable that the graphic is such that the evaluation value calculated for each road segment can be intuitively understood.

For example, the map generation unit 1012 may generate the graphic in a warm color if the fuel efficiency of the own vehicle is better and generate the graphic in a cold color if the fuel efficiency of the own vehicle is worse to superimpose the graphic on the corresponding road segment on the road map. Thereby, it is possible to visualize whether the fuel efficiency of the own vehicle is good or bad.

In the description below, a road map on which a graphic corresponding to an evaluation value is superimposed on a road segment will be referred to as a “fuel efficiency map”.

The storage 102 is for storing information and is configured with a storage medium such as a RAM, a magnetic disk, or a flash memory. In the storage 102, various kinds of programs executed by the controller 101, data used by the programs, and the like are stored. Furthermore, the fuel efficiency database 102A described before and road map data 102B are stored in the storage 102.

The fuel efficiency database 102A is a database in which the fuel efficiency information described with reference to FIG. 3 is stored.

The road map data 102B is map data of roads that the vehicle 10 can travel. The road map data 102B may include definitions of road segments.

The communication unit 103 is a communication interface for connecting the onboard apparatus 100 to the bus of the onboard network.

The communication unit 103 may include an interface for performing CAN (controller area network) communication in the vehicle.

An input/output unit 104 is for accepting an input operation performed by the user and presenting information to the user. Specifically, the input/output unit 104 is configured with a touch panel and control unit therefor, and a liquid crystal display and control unit therefor. In the present embodiment, the touch panel and the liquid crystal display are configured with one touch panel display. The input/output unit 104 may include a unit for outputting voice (an amplifier and a speaker), a unit for inputting voice (a microphone), and the like.

The position information acquisition unit 105 acquires position information about the vehicle 10 and identifies a road segment that the vehicle 10 is traveling. The position information acquisition unit 105 includes a GPS antenna and a positioning module for obtaining the position information. The GPS antenna is an antenna that receives a positioning signal transmitted from a positioning satellite (also referred to as a GNSS satellite). The positioning module is a module that calculates position information based on a signal received by the GPS antenna.

The position information acquisition unit 105 also has a function of identifying a road segment that the vehicle 10 is currently traveling, by referring to the road map data 102B to be described later.

Note that the configurations illustrated in FIG. 2 is mere example, and all or a part of the illustrated functions may be executed with dedicatedly designed circuits. Furthermore, storage and execution of the program may be performed by a combination of a main memory and an auxiliary storage device other than the illustrated combination.

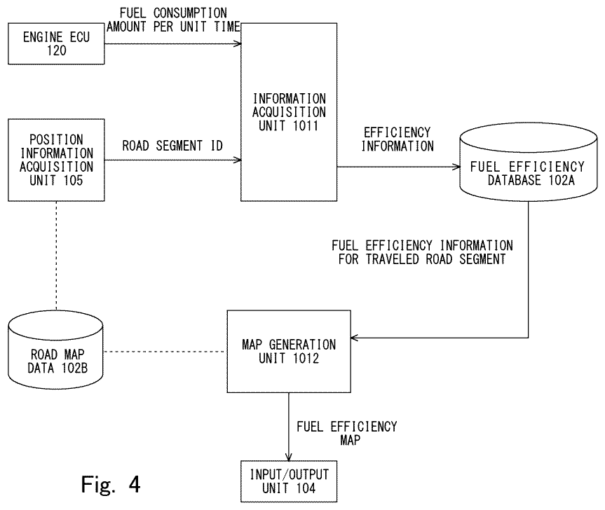

Next, specific content of the process performed by the onboard apparatus 100 will be described. FIG. 4 is a diagram illustrating a flow of data among components of the onboard apparatus 100.

While the vehicle 10 is traveling, the information acquisition unit 1011 periodically acquires data indicating a fuel consumption amount per unit time from the engine ECU 120. In parallel therewith, the information acquisition unit 1011 acquires information that identifies a road segment that the vehicle 10 is currently traveling (a road segment ID) from the position information acquisition unit 105. By collating the acquired position information with the road map data 102B, the position information acquisition unit 105 identifies the road segment that the vehicle 10 is currently traveling and provides the identifier of the road segment to the information acquisition unit 1011.

The information acquisition unit 1011 associates the acquired road segment with a total amount of fuel consumed in the road segment to generate fuel efficiency information as illustrated in FIG. 3. The generated fuel efficiency information is stored in the fuel efficiency database 102A.

In the fuel efficiency database 102A, a plurality of road segments through which the vehicle 10 has passed and amounts of fuel consumed in the road segments are accumulated in association with each other.

The map generation unit 1012 starts operation at a timing for generating a fuel consumption map.

The generation of the fuel consumption map may be performed according to the instructions of the occupants of the vehicle 10, or may be performed automatically when the vehicle 10 finishes driving.

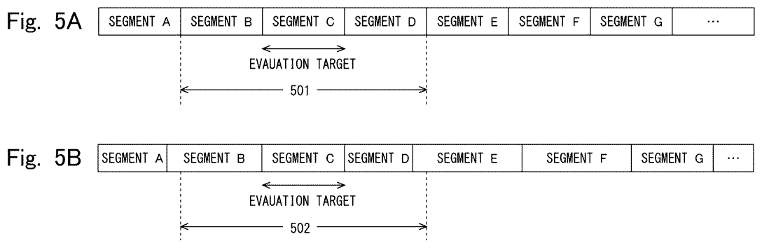

The map generation unit 1012 identifies a plurality of road segments traveled by the vehicle 10 and acquires fuel efficiency information corresponding to the plurality of road segments from the fuel efficiency database 102A. FIGS. 5 and 5B are diagrams illustrating a road segment traveled by the vehicle 10. Here, vehicle 10 is a road segment A, B, C, D . . . . It shall be assumed that the vehicle has traveled in the order of.

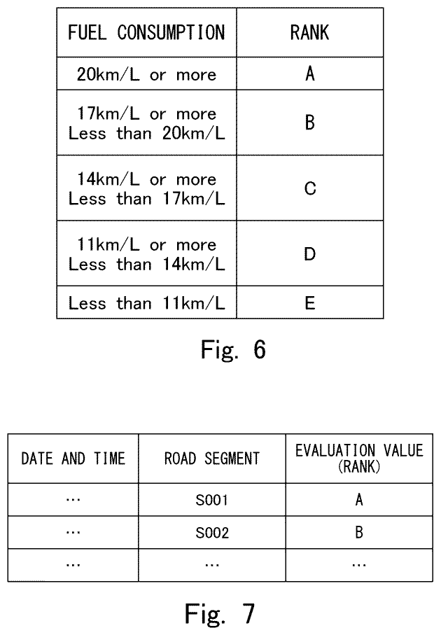

The map generation unit 1012 assigns value of evaluations in order for a plurality of road segment traveled by the vehicle 10. In the present embodiment, the value of evaluation is a ranking of the mileage (fuel consumption rate) per unit liquid amount of fuel. FIG. 6 is an example of a standard for calculating a value of evaluation. In this example, the longer the mileage per unit liquid of fuel, the higher rank is assigned. For example, if the length of the section to be evaluation targeted is 500 m and the fuel consumed to run the section is 40 cc, the mileage per liter of fuel is 12.5 km, so the rank is “D”. In addition, if the fuel consumed to run in the same section is 25 cc, the mileage per liter of fuel is 20 km, so the rank is “A”.

The value of evaluation can be calculated on a per-road segment basis.

For example, an evaluation value (rank) for road segment A can be calculated based on the length of road segment A and the amount of fuel consumed in road segment A.

However, when this configuration is adopted, depending on the length of the road segment, the evaluation fluctuates for each short section, and the fuel efficiency map may be difficult to see. For example, if there is an area where road segments are separated every 100 m and an area where road segments are separated every 500 m, the visibility of the fuel efficiency map will deteriorate in the former.

Therefore, in the present embodiment, the section for actually acquiring fuel efficiency information is longer than the road segment to be evaluation targeted.

This will be described with reference to FIG. 5A.

In the conventional method, for example, when road segment C was an evaluation target, the value of evaluation for road segment C was determined based on the amount of fuel consumed in road segment C.

On the other hand, in the present embodiment, the evaluation value for the road segment C is determined based on the amount of fuel consumed in a plurality of road segments, including road segments before and after the road segment C.

In this example, for example, after acquiring the total amount of fuel consumed in the three sections (reference numeral 501) of road segment B, C, and D and the total length of the three sections, the mileage per unit liquid amount of fuel is obtained and the rank is determined. That is, the rank determined based on the amount of fuel consumed in the section indicated by reference numeral 501 is the evaluation for segment C.

In the example of FIG. 5A, a total of three road segments including one before and after the road segment to be evaluation targeted were used as sections for calculating fuel consumption amount, but the boundary of the section for calculating fuel consumption amount does not necessarily have to coincide with the boundary of the road segment.

For example, as shown in FIG. 5B, a section having a predetermined length (reference numeral 502) that is unrelated to the road segment may be defined, and a value of evaluation may be generated based on the amount of fuel consumed in the section. In this case, the fuel consumption in the section may be obtained by apportioning the fuel consumption for each road segment by distance.

For example, the amount of fuel consumed in the section indicated by reference numeral 502 can be determined by summing the following.

A value obtained by proportionally dividing the fuel consumption amount in road segment B according to the distance belonging to section 502 in road segment B

Fuel consumption amount in road segment C

Fuel consumption amount in road segment D

A value obtained by proportionally dividing the fuel consumption in road segment E according to the distance belonging to section 502 in road segment E

According to such a configuration, since the evaluation result is generated based on the moving average of the fuel consumption amount, the fluctuation of the evaluation result is equalized, and the effect of making it easier to see the road map after mapping can be obtained.

By executing the above process for each road segment, a value of evaluation for each road segment passed by the vehicle 10 can be obtained.

FIG. 7 is an example of a value of evaluation obtained for each road segment.

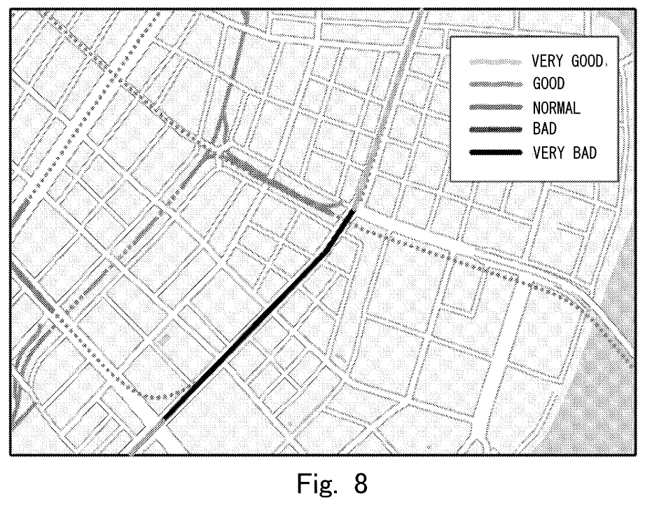

When the value of evaluation is calculated for each road segment, the map generation unit 1012 superimposes a graphic on the road map based on the value of evaluation. FIG. 8 is an example of a road map (fuel efficiency map) in which graphics are superimposed. The fuel efficiency map includes a plurality of road segments traveled by the vehicle 10. In this example, a plurality of road segments included in the road map are colored according to the value of evaluation (rank). For example, road segments that have better fuel efficiency may be colored in warm colors, and road segments that are not may be colored in cool colors. In the example of FIG. 8, the rank is represented by shades. As a result, it will be possible to grasp at a glance what the fuel efficiency of the own vehicle is.

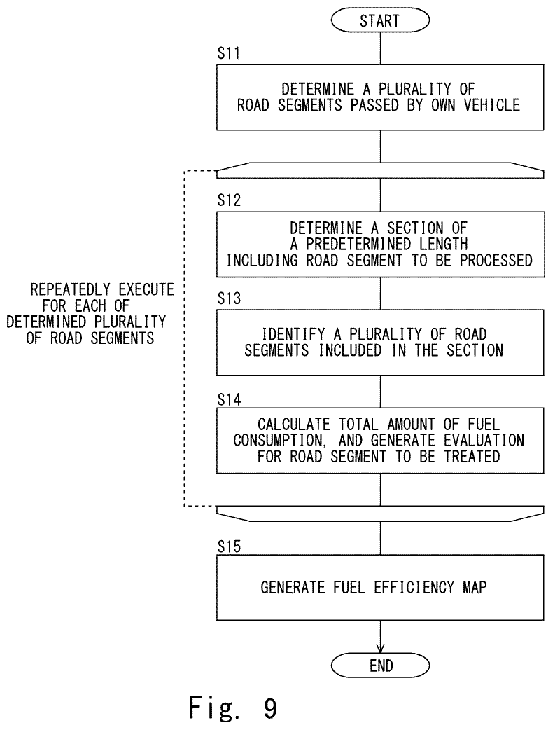

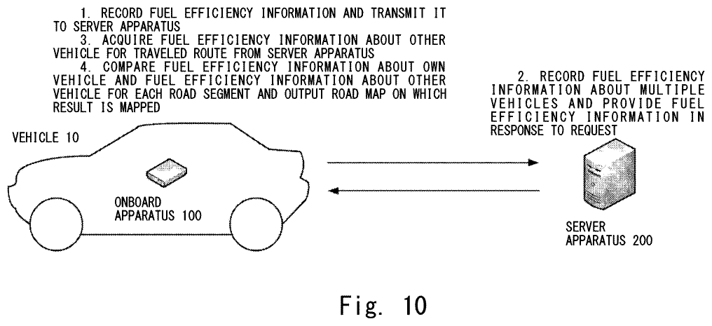

FIG. 9 is a flowchart of a process performed by the onboard apparatus 100 in the present embodiment. The illustrated process is executed by the map generation unit 1012.

First, in step S11, a plurality of road segments passed by the vehicle 10 are determined. The plurality of road segments passed by the vehicle 10 can determined based on the stored fuel efficiency information.

The processing of steps S12 to S14 is repeatedly executed for each of the determined plurality of road segments. In step S12, the map generation unit 1012 determines a section of a predetermined length including the road segment to be processed. The predetermined length can be, for example, a certain length such as 500 m.

Next, in step S13, a plurality of road segments included in the section are identified. For example, in the example of FIG. 5B, road segments B, C, and D are specified.

Next, in step S14, the total amount of fuel consumption within the section of a predetermined length is calculated based on the fuel consumption corresponding to the specified plurality of road segments. For example, when the road segment C in FIG. 5B is the processing target and the section indicated by reference numeral 502 is set as a section of a predetermined length, the amount of fuel consumed in the section indicated by reference numeral 502 is calculated. The fuel consumption of the sections included in the road segments B and E of the section 502 may be obtained by apportioning the fuel consumption in the entire road segments B and E by the distance.

Then, based on the calculated fuel consumption amount, an evaluation is generated for the road segment to be treated (here, road segment C). The evaluation can be determined, for example, on the basis of the mileage per unit liquid volume of fuel. As a result, an evaluation result as shown in FIG. 7 is generated for each road segment.

In step S15, a graphic is superimposed on the road map based on the calculated evaluation result. For example, a graphic with a color corresponding to a rank is superimposed on the corresponding road segment. As a result, the result of ranking the fuel efficiency of the own vehicle is mapped on the road map for each road segment. The road map after mapping may be output to a display included in the onboard apparatus 100 or may be transmitted to a device associated with the occupants of the vehicle 10.

As described above, in the vehicle system according to the present embodiment, the fuel efficiency of the own vehicle road segment, and the result is mapped on a road map. In addition, at this time, the section for which fuel efficiency information is actually obtained is longer than the road segment to be evaluated. As a result, since the fluctuation of the evaluation result is slow, even when the road segment to be evaluation targeted is a short distance, it is possible to obtain the effect that the road map after mapping is easier to see.

### Second Embodiment

In the first embodiment, an evaluation was performed for own vehicle road segment based on the amount of fuel consumed by the vehicle (absolute value). On the other hand, the second embodiment is an embodiment in which the fuel consumption of the own vehicle is relatively evaluated using the fuel consumption of other vehicles that have passed through the same road segment as the own vehicle.

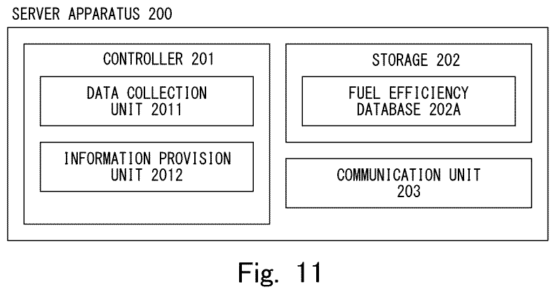

FIG. 10 is a schematic diagram of the vehicle system in the second embodiment.

The vehicle system in the second embodiment further includes a server apparatus 200.

The server apparatus 200 is a database device that receives fuel efficiency information from a plurality of vehicles 10 (onboard apparatus 100) and stores it in association with road segments.

The onboard apparatus 100 stores the amount of fuel consumed during driving for each road segment traveled, and transmits the stored information to the server apparatus.

The fuel efficiency information transmitted by the plurality of vehicles 10 (onboard apparatus 100) is stored in the server apparatus 200 and provided to any vehicle 10 (onboard apparatus 100) upon request.

When the vehicle 10 ends traveling, the onboard apparatus 100 outputs information about the fuel efficiency of the traveling.

At this time, the onboard apparatus 100 acquires fuel efficiency information about another vehicle from the server apparatus 200. The fuel efficiency information includes fuel efficiency information about the other vehicle that traveled one or more road segments that the vehicle 10 has traveled. The onboard apparatus 100 compares the fuel efficiency of the own vehicle and the fuel efficiency of the other vehicle based on the stored fuel efficiency information about the own vehicle and the fuel efficiency information about the other vehicle acquired from the server apparatus 200, and maps the result of the comparison on a road map for each road segment.

Thereby, the driver of the vehicle 10 can recognize how fuel-efficient driving they perform in comparison with the other vehicle.

The server apparatus 200 executes a process for collecting pieces of fuel efficiency information from a plurality of vehicles 10 (onboard apparatuses 100) and storing them into a database and a process for providing fuel efficiency information corresponding to a plurality of vehicles 10 that traveled a specified road segment in the past, in response to a request from the outside.

FIG. 11 is a diagram illustrating components of the server apparatus 200 included in the vehicle system according to the present embodiment in detail.

The server apparatus 200 can be configured as a computer that includes processors such as a CPU and a GPU, main memories such as a RAM and a ROM, and auxiliary storage devices such as an EPROM, a hard disk drive, and a removable medium. In the auxiliary storage device, an operating system (OS), various kinds of programs, various kinds of tables, and the like are stored. Functions meeting predetermined purposes as described later can be realized by loading programs stored in the auxiliary storage device to a work area of the main memory, executing the programs, and ethe components and the like being controlled through the execution of the programs. A part or all of the functions, however, may be realized by a hardware circuit like an ASIC and an FPGA.

The server apparatus 200 is configured including a controller 201, a storage 202, and a communication unit 203.

The controller 201 is an operation device responsible for control performed by the server apparatus 200. The controller 201 can be realized by an operation processing device such as a CPU.

The controller 201 is configured including a data collection unit 2011 and an information provision unit 2012 as function modules. Each of the function modules may be realized by executing a stored program by the CPU.

The data collection unit 2011 executes a process for collecting pieces of fuel efficiency information from a plurality of vehicles 10 (onboard apparatuses 100) and storing them into a fuel efficiency database 202A to be described later.

When receiving pieces of fuel efficiency information from a plurality of vehicles 10 (onboard apparatuses 100), the data collection unit 2011 stores them into the fuel efficiency database 202A. The fuel efficiency database 202A is a database including columns similar to those illustrated in FIG. 3.

While the fuel efficiency database 102A stores fuel efficiency information about an own vehicle, the fuel efficiency database 202A stores pieces of fuel efficiency information about a plurality of vehicles.

In response to a request from the onboard apparatus 100, the information provision unit 2012 extracts fuel efficiency information corresponding to a plurality of vehicles 10 that traveled a specified road segment in the past from the fuel efficiency database 202A and transmits it to the onboard apparatus 100.

Note that the onboard apparatus 100 that transmits the fuel efficiency information to the server apparatus 200 and the onboard apparatus 100 that requests the fuel efficiency information from the server apparatus 200 may be separate apparatuses.

The storage 202 is configured including a main memory and an auxiliary storage device. The main memory is a memory where a program executed by the controller 201 and data used by the control program are developed. The auxiliary storage device is a device in which the program executed by the controller 201 and the data used by the control program are stored.

Furthermore, the fuel efficiency database 202A is stored in the storage 202.

The fuel efficiency database 202A is a database in which fuel efficiency information (FIG. 3) transmitted from the onboard apparatus 100 is stored. In the fuel efficiency database 202A, a plurality of pieces of fuel efficiency information transmitted from the plurality of vehicles 10 (the onboard apparatuses 100) are stored.

The communication unit 203 is a communication interface for connecting the server apparatus 200 to a network. The communication unit 203 is configured, for example, including a network interface board and a wireless communication interface for wireless communication.

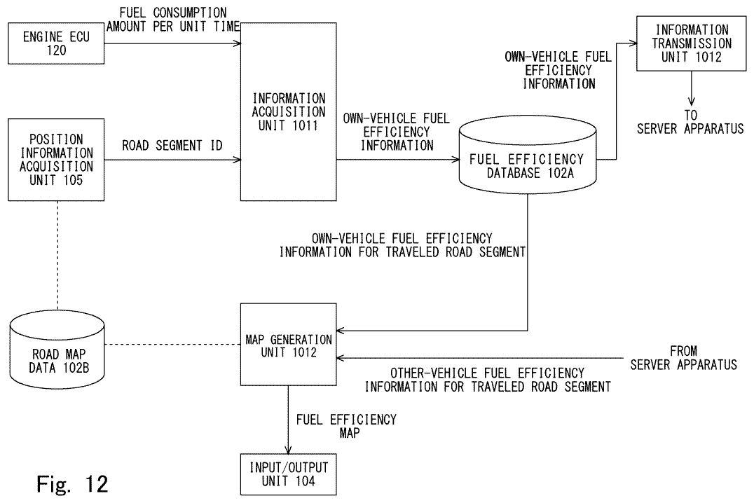

Next, specific content of the process performed by the onboard apparatus 100 in the second embodiment will be described. FIG. 12 is a diagram illustrating a flow of data among components of the onboard apparatus 100 in the second embodiment.

The information acquisition unit 1011 generates fuel efficiency information as shown in FIG. 3 in the same manner as in the first embodiment. In the present embodiment, the fuel efficiency information generated by the own vehicle is referred to as the own-vehicle fuel efficiency information. The generated own-vehicle fuel efficiency information is stored in the fuel efficiency database 102A. Further, the information acquisition unit 1011 transmits the generated own-vehicle fuel efficiency information to the server apparatus 200 at a predetermined timing. The transmission timing may be a timing when the vehicle 10 transitions between road segments or may be a timing when traveling of the vehicle 10 ends (for example, at a timing when the vehicle system is shut down).

It is conceivable that the vehicle 10 stops in a particular segment for a long time. Fuel efficiency information obtained in such a case is not appropriate as data for comparing fuel efficiency. Therefore, if such a case occurs, corresponding own-vehicle fuel efficiency information may be excluded from transmission to the server apparatus 200. Furthermore, for this determination, the information acquisition unit 1011 may acquire data indicating a vehicle speed, a shift position, the state of the parking brake, or the like from the engine ECU 120.

The map generation unit 1012 starts operation at a timing of making a comparison of fuel efficiency.

The comparison of fuel efficiency may be made in response to an instruction by the occupant of the vehicle 10 or may be automatically performed at a timing when the vehicle 10 ends traveling.

The map generation unit 1012 identifies the plurality of road segments that the vehicle 10 has traveled, and acquires pieces of own-vehicle fuel efficiency information corresponding to the plurality of road segments from the fuel efficiency database 102A. FIG. 7 is a diagram exemplifying the road segments that the vehicle 10 has traveled. Here, it is assumed that the vehicle 10 has traveled road segments A, B, C, and D in that order.

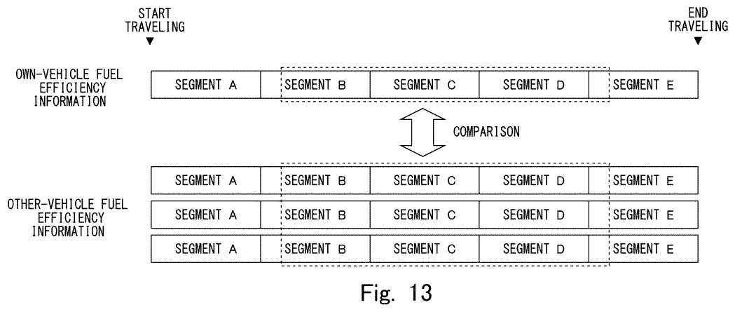

Furthermore, the map generation unit 1012 acquires other-vehicle fuel efficiency information corresponding to the same road segments from the server apparatus 200. Here, pieces of fuel efficiency information transmitted from other vehicles that traveled the same road segments are targeted by the acquisition. In the illustrated example, pieces of fuel efficiency information about other vehicles (other-vehicle fuel efficiency information) are acquired for each road, such as pieces of fuel efficiency information about a plurality of vehicles that traveled the road segment A, pieces of fuel efficiency information about a plurality of vehicles that traveled the road segment B, . . . . In the example of FIG. 13, it is assumed that three other vehicles traveled the same road segments.

It is desirable that the fuel efficiency information comparison is made using vehicles that travel with fuel consumption rates similar to the fuel consumption rate of the target vehicle 10. Therefore, it is desirable to acquire the other-vehicle fuel efficiency information from other vehicles having the same or similar vehicle attributes.

For example, the map generation unit 1012 may notify the server apparatus 200 of the attribute of the vehicle 10, and the server apparatus 200 may extract pieces of fuel efficiency information transmitted from vehicles 10 having attributes that are the same as or similar to the attribute to generate other-vehicle fuel efficiency information.

As the attribute of the vehicle 10, for example, vehicle type, model name, vehicle size, vehicle weight, vehicle capacity, fuel type, or drive method is exemplified.

The attributes of the vehicle may be transmitted from the onboard apparatus 100 to the server apparatus 200 in conjunction with the fuel efficiency information.

That is, vehicle attributes may be further associated with the fuel efficiency information shown in FIG. 3

The map generation unit 1012 that acquires the own-vehicle fuel efficiency information of the own vehicle, and the other-vehicle fuel efficiency information compares the fuel efficiency between the own vehicle and other vehicles, and assigns the results to each of the plurality of road segments.

In the second embodiment, as in the first embodiment, the section for actually acquiring fuel efficiency information is longer than the road segment to be evaluated. For example, in the example of FIG. 13, when the evaluation target is a road segment C, the fuel consumption of the own vehicle and the fuel consumption of other vehicles are acquired and compared for the section indicated by the dotted line. When the road segment evaluation targeted changes, the section indicated by the dotted line also moves.

The map generation unit 1012 generates a value of evaluation as a result of the comparison and assigns it to the road segment C.

Here, a method of comparing the own-vehicle fuel efficiency information and the other-vehicle fuel efficiency information and generating a value of evaluation based on this result will be described.

### (1) Method 1

As a typical method, there is a method of determining an average value of fuel consumption amounts of a plurality of other vehicles and comparing the average value with the fuel consumption amount of the own vehicle. For example, a case where N other vehicles V₁ to V_{N} are traveling a certain road section will be considered. The average value μ of the fuel consumption amounts can be expressed by the following formula:

μ=(Cᵥ₁+Cᵥ₂+Cᵥ₃+ . . . +C_{vN})/N

where, Cᵥ₁ to C_{vN} are fuel consumption amounts of the vehicles in the road section.

By calculating a rate of the fuel consumption amount of the own vehicle to the determined value, an evaluation value can be obtained. The evaluation value may be expressed by μ/Cᵥₛ, where Cᵥₛ is the fuel consumption amount of the own vehicle.

When the evaluation value obtained here is larger than 1, it can be determined that the fuel efficiency of the own vehicle is favorable in comparison with the other vehicles.

### (2) Method 2

As one of the comparison methods, there is a method of determining the deviation value.

Specifically, the variance σ of the fuel consumption amounts Cᵥ₁ to C_{vN} of the vehicles in the target section is determined, and the deviation value of the fuel consumption amount of the own vehicle can be calculated based on the variance σ. In this example, the variation value is the evaluation value.

σ=√{(Cᵥ₁−μ)²+(Cᵥ₂−μ)²+ . . . +(C_{vN}−μ)²}/(N−1)

Deviation value=−{(Cᵥₛ−μ)/σ}×10+50

When the evaluation value obtained here is larger than 50, it can be determined that the fuel efficiency of the own vehicle is favorable in comparison with the other vehicles.

### (3) Method 3

As another comparison method, there is a method of determining the percentile of the fuel consumption amount.

That is, the fuel consumption amounts of the own vehicle and other vehicles in the target section and are arranged in order, and the evaluation value is calculated as the percentage position at which the own vehicle is located. Thereby, it is possible to know the rank of the own vehicle in the whole.

By executing the above process while changing the road segment to be evaluation targeted, an evaluation value is obtained for each road segment through which the vehicle 10 has passed.

When a value of evaluation is calculated for each road segment, the map generation unit 1012 superimposes a graphic on the road map based on the calculated value of evaluation in the same manner as in the first embodiment.

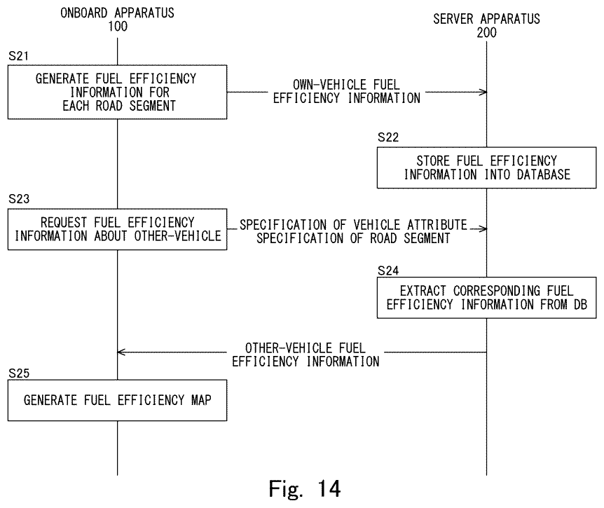

FIG. 14 is a diagram illustrating a flow of a process performed by the onboard apparatus 100 and the server apparatus 200 in the second embodiment.

First, at Step S21, the information acquisition unit 1011 generates own-vehicle fuel efficiency information. As described before, the information acquisition unit 1011 generates the fuel efficiency information as illustrated in FIG. 3 using a fuel consumption amount per unit time acquired from the engine ECU 120 and an identifier of a road segment acquired from the position information acquisition unit 105. The generated fuel efficiency information is stored into the fuel efficiency database 102A and transmitted to the server apparatus 200.

At step S22, the server apparatus 200 (the data collection unit 2011) stores the received fuel efficiency information into the fuel efficiency database 202A.

The processes of steps S21 and S22 are executed at a timing when the vehicle 10 leaves the road segment or at a timing when traveling of the vehicle 10 is completed.

When starting generation of a fuel efficiency map, at step S23, the onboard apparatus 100 requests fuel efficiency information about another vehicle from the server apparatus 200. At this step, the identifiers of the plurality of road segments through which the vehicle 10 has passed and information about the attribute of the vehicle 10 are transmitted to the server apparatus 200.

At step S24, the server apparatus 200 extracts fuel efficiency information about other vehicle that passed through the specified road segments. At the present step, fuel efficiency information transmitted from a vehicle having the specified attribute is targeted by the extraction. The fuel efficiency information (other-vehicle fuel efficiency information) extracted by the server apparatus 200 is transmitted to the onboard apparatus 100.

At step S25, the onboard apparatus 100 calculates evaluation values for the road segments, respectively, by the methods described before, based on the own-vehicle fuel efficiency information and the other-vehicle fuel efficiency information, and superimposes graphics on the road segments based on the evaluation values. Thereby, results of comparing the fuel efficiency of the own vehicle and the fuel efficiency of the other vehicle are mapped on the road map. The road map may be outputted to a display of the onboard apparatus 100 or may be transmitted to an apparatus associated with the occupant of the vehicle 10.

As described above, in the vehicle system according to the second embodiment, each of the plurality of vehicles 10 reports a fuel consumption amount in a road segment through which the vehicle 10 has passed, to the server apparatus 200, and the server apparatus 200 stores the fuel consumption amount. Stored fuel efficiency information is provided for the other onboard apparatus 100 in response to a request, and the onboard apparatus 100 compares the fuel efficiency of the own vehicle and the fuel efficiency of the other vehicle based on the fuel efficiency information acquired from the server apparatus 200 and maps the result of the comparison on a road map. Thereby, it becomes possible for the user (for example, the driver) of the vehicle 10 to grasp whether their driving is appropriate in comparison with the other vehicle.

Furthermore, since the other vehicle targeted by the comparison is selected based on the attribute of the vehicle, comparison between vehicles having almost the same fuel consumption rates is possible.

### (Modification 1 of Second Embodiment)

In the second embodiment, the onboard apparatus 100 acquires fuel efficiency information about the own vehicle that has traveled a predetermined road segment and fuel efficiency information about a plurality of other vehicles that traveled the road segment, and performs calculation for comparing them. A part of the calculation for performing the comparison, however, may be executed in the server apparatus 200. For example, the average value of fuel consumption amounts illustrated in the method 1 and the variance of fuel consumption amounts illustrated in the method 2 may be calculated in the server apparatus 200. In this case, after extracting the other-vehicle fuel efficiency information at step S24, the server apparatus 200 may execute a process for performing such calculation and notifying the onboard apparatus 100 of the obtained value.

Furthermore, calculation and ranking of evaluation values may be executed by the server apparatus 200. For example, in the process of step S23, the onboard apparatus 100 may further notify the server apparatus 200 of own-vehicle fuel efficiency information, and the server apparatus 200 may perform calculation and ranking of evaluation values based on the notification.

In this case, the server apparatus 200 may transmit information indicating the evaluation values and ranks of road segments (information for generating a fuel efficiency map) to the onboard apparatus 100 instead of the other-vehicle fuel efficiency information. Furthermore, the onboard apparatus 100 that receives the information may generate the fuel efficiency map using the information.

Furthermore, though the onboard apparatus 100 associates each road segment with a fuel consumption amount in the second embodiment, the server apparatus 200 may associate each road segment with a fuel consumption amount. In this case, the onboard apparatus 100 generates fuel efficiency information that includes position information, instead of each road segment, and the server apparatus 200 may calculate an amount of fuel consumed in each road segment based on the position information.

### (Modification 2 of Second Embodiment)

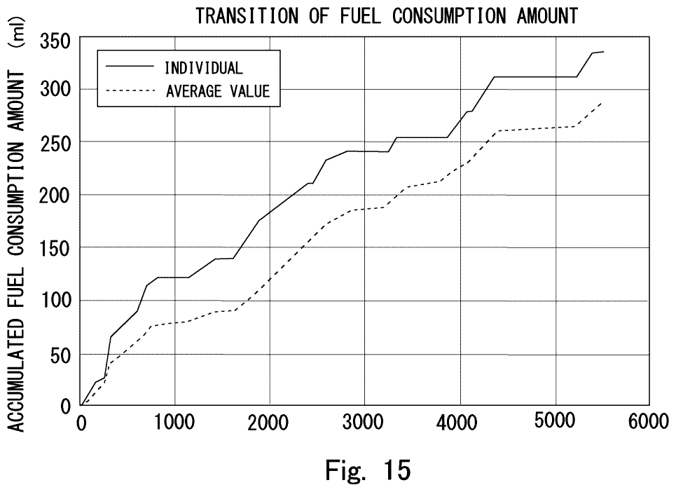

Though the onboard apparatus 100 generates a fuel efficiency map as a result of comparing fuel efficiency in the second embodiment, the onboard apparatus 100 may graph transition of the fuel consumption amount in a route that the vehicle 10 has traveled. FIG. 15 illustrates an example of an image illustrating transition of the fuel consumption amount in a route that the vehicle 10 has traveled, using graphs. Such a graph can be obtained by accumulating fuel consumption amounts for a plurality of road segments included in the route that the vehicle 10 has traveled. On the graph, fuel consumption amount (average value) of other vehicles that traveled the same road segments may be plotted.

The onboard apparatus 100 may be configured to be capable of switching between the fuel efficiency map and the graph illustrated in FIG. 15. Furthermore, being triggered by any point on the graph being selected, the onboard apparatus 100 may display a corresponding road segment on the fuel efficiency map.

### (Modification 3 of Second Embodiment)

In the second embodiment, the server apparatus 200 extracts fuel efficiency information about other vehicles that passed through a specified road segment in the past, and the onboard apparatus 100 makes a comparison of fuel efficiency based on the fuel efficiency information. The accuracy of the comparison result, however, can vary depending on the number of other vehicles that traveled the road segment. For example, the accuracy of the comparison result for a road segment that ten vehicles travel a day and the comparison result for a road segment that three thousand vehicles travel a day are different. Therefore, the form of a graphic to be mapped on a road map may be decided based on the number of other vehicles used for comparison. For example, for a particular road segment, a thicker line may be superimposed as the number of other vehicles that passed during a predetermined period in the past is larger. Thereby, the accuracy of the comparison result can be intuitively indicated. Though line thickness is exemplified as the form of the graphic in the present example, the number of other vehicles used for comparison may be expressed otherwise.

### (Modification 4 of Second Embodiment)

Though an evaluation value is acquired as the result of comparing fuel efficiencies in the first embodiment, information such as “where in the whole the own vehicle is located” may be presented in order to encourage improvement of driving behavior.

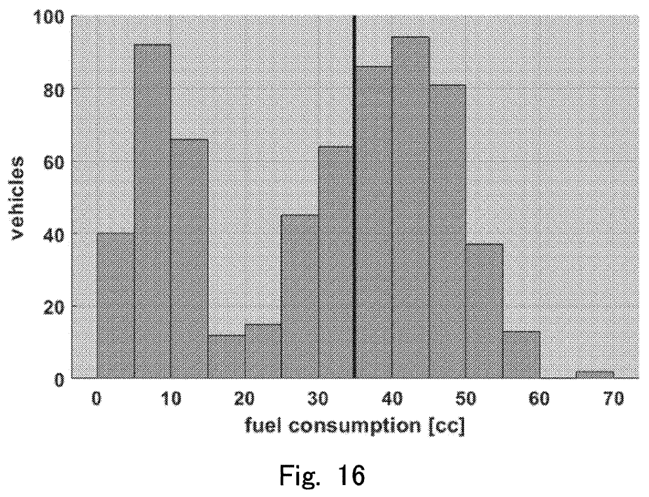

For example, a fuel consumption amount histogram on one road segment may be generated based on other-vehicle fuel efficiency information and outputted together with the position of the own vehicle. FIG. 16 illustrates an example of a histogram generated based on fuel consumption amounts of a plurality of other vehicles. The histogram can be generated based on own-vehicle fuel efficiency information and other-vehicle fuel efficiency information. Where in the histogram the own vehicle is located may be indicated, for example, by a marker. According to such a configuration, it becomes possible to easily grasp the position of the own vehicle in the whole.

### (Modification 5 of Second Embodiment)

In the second embodiment, at step S24, the server apparatus 200 extracts fuel efficiency information from the database with two keys of a vehicle attribute and a road segment. However, a fuel consumption amount in a certain road segment can significantly vary by a traffic jam situation and the like.

Therefore, in extracting fuel efficiency information at step S24, conditions such as day of the week, time zone, and date may be used. For example, a condition under which the vehicle 10 has traveled a target road segment, such as “between 18 and 19 p.m. on a weekday”, may be specified to extract fuel efficiency information using the condition. The condition may be specified by the onboard apparatus 100 or may be automatically added by the server apparatus 200.

According to such a configuration, since it becomes possible to acquire fuel efficiency information about other vehicles that traveled under similar situations, the comparison accuracy can be improved.

### (Modifications)

The above embodiments are mere examples, and the present disclosure can be appropriately changed and practiced within a range not departing from its spirit.

For example, the processes and components described in the present disclosure can be freely combined and implemented as far as technical contradiction does not occur.

The fuel in the present disclosure may be volatile oil (such as gasoline and light oil), gas such as hydrogen, or liquid obtained by compressing the gas. Furthermore, though a consumption amount of gasoline is exemplified as fuel efficiency information in the description of the embodiments, when a target is an electric vehicle, it is possible to perform calculation using a consumption amount of power (power efficiency information).

Furthermore, a process described as being performed by single apparatus may be shared and executed by a plurality of apparatuses. In contrast, processes described as being performed by different apparatuses may be executed by single apparatus. In a computer system, what hardware configuration (server configuration) each function is realized by can be flexibly changed.

The present disclosure can be realized by supplying a computer program implemented with the functions described in the above embodiments to a computer and one or more processors of the computer reading out and executing the program. Such a computer program may be provided for the computer by a non-transitory computer-readable storage medium connectable to a system bus of the computer or may be provided for the computer via a network. As the non-transitory computer-readable storage medium, for example, any type of disk such as a magnetic disk (a floppy (registered trademark) disk, a hard disk drive (HDD), or the like), and an optical disc (a CD-ROM, a DVD disc, a Blu-ray disc, or the like), a read-only memory (ROM), a random-access memory (RAM), an EPROM, an EEPROM, a magnetic card, a flash memory, an optical card, and any type of medium that is appropriate for storing electronic commands are included.

What is claimed is:

1. An information processing apparatus comprising a controller, the controller being configured to execute:
acquiring first data about an amount of fuel or power consumed when a first vehicle passes through each of a plurality of first road segments;
generating, based on the first data, first information on the fuel or power consumption amounts of the first vehicle in a section of a predetermined length that includes the first road segment; and
mapping the first information on the first road segment on a road map.

2. The information processing apparatus according to claim 1, wherein the controller overlays a graphic for presenting the first information, on the first road segment included in the road map.

3. The information processing apparatus according to claim 2, wherein the controller decides color of the graphic based on the fuel or power consumption amount of the first vehicle.

4. An information processing apparatus comprising a controller, the controller being configured to execute:
acquiring first data about an amount of fuel or power consumed when a first vehicle passes through a first road segment;
acquiring second data about amounts of fuel or power consumed when a plurality of second vehicles pass through the first road segment;
generating, based on the first and second data, first information that is a result of comparing the fuel or power consumption amounts in a section of a predetermined length that includes the first road segment, between the first vehicle and the plurality of second vehicles; and
mapping the first information on the first road segment on a road map.

5. The information processing apparatus according to claim 4, wherein the plurality of second vehicles are vehicles having a same attribute as the first vehicle.
